(19) United States
(12) Patent Application Publication
(10) Pub. No.: US 2009/0116734 A1
(43) Pub. Date: May 7, 2009

(54) IMAGE CLASSIFICATION

(75) Inventor: Christopher Jon Willis, Chelmsford (GB)

Correspondence Address: KENYON & KENYON LLP, ONE BROADWAY, NEW YORK, NY, 10004, US

(73) Assignee: BAE SYSTEMS PLC, London (GB)

(21) Appl. No.: 10/593,019

(22) PCT Filed: Mar. 15, 2005
(86) PCT No.: PCT/GB2005/000981

§ 371 Date: Jan. 14, 2009

(30) Foreign Application Priority Data
Mar. 15, 2004 (GB) 0405741.0

(51) Int. Cl. G06K 9/62

(52) U.S. Cl. 382/159

(57) ABSTRACT

An apparatus and method are provided for classifying elements in an image, in particular elements of a hyperspectral image, where an element is defined by a vector of feature values. The apparatus includes a classifier arrangement comprising a number of classifiers each operable, in respect of an element to be classified, to receive a different predetermined subset of the feature values from the element feature vector and wherein, in operation, each classifier is trained in respect of a predetermined set of classes using training data representative of elements in each class; and a combining arrangement operable to combine outputs from the classifiers to determine which of the predetermined classes to associate with an element to be classified, wherein each of the different predetermined subsets of feature values comprise a different cyclic selection of the feature values such that, in operation, adjacent feature values in an element feature vector are input to different ones of the classifiers and all feature values are input to at least one classifier.

### RELATED APPLICATION INFORMATION

This application is a U.S. National Phase Patent Application of, and claims the benefit of, International Patent Application No. PCT/GB2005/000981 which was filed on Mar. 15, 2005, and which claims priority to British Patent Application No. 0 405 741.0, which was filed in the British Patent Office on Mar. 15, 2004, the disclosures of which are hereby incorporated by reference.

### FIELD OF THE INVENTION

The present invention relates to an apparatus and method for classifying images and in particular for classifying elements within images. The present invention is particularly, but not exclusively, useful for classifying pixels within hyperspectral images within the optical and non-optical domain.

### BACKGROUND INFORMATION

The classification of spectral signatures in hyperspectral imagery is used for the identification of land cover types and may be used for the identification of specific target objects of interest where their spectral characteristics are known. The typical approach to this type of classification problem uses a set of “training data” to characterise the statistical distributions of regions (“classes”) of known land cover type. These class distributions may then, in turn, be used to recognise previously unseen samples of the same type of data, the latter samples being assigned to one of the classes of training data.

The major problem with this approach is that a large number of training samples of each class type are typically needed to completely characterise the statistical distribution of each of the classes. Thus a very large training dataset needs to be assembled. The assembly of a training dataset for hyperspectral imagery is usually done by carrying out data collection trials in the field; an expensive and time-consuming operation.

In recent times a number of new statistical techniques have been developed which reduce the volume of training data required, at the expense of considerably increased complexity in the classification process. An example of such a technique is discussed by Skurichina, M and Duin, R. P. W., in “Bagging and the Random Subspace Method for Redundant Feature Spaces”, Proceedings of the 2^{nd} International Workshop on Multiple Classifier Systems, Cambridge, UK, pp 1-10, July 2001. One such technique, the Random Subspace Method (RSM), has been applied, as discussed by Willis, C. J., in “Classification of Hyperspectral Imagery using Limited Training Data Samples”, Proceedings of SPIE, Image and Signal Processing for Remote Sensing VIII, 4885, pp 379-388, 2003, to hyperspectral data allowing a considerable reduction in the volume of training data required for only a modest reduction in classification performance. The RSM builds an ensemble of classifiers each based on a different view of the training dataset. The output of each member of 1 5 the classifier ensemble, when applied to new sample data, is combined to produce the ensemble classification. It is normal for the combination method to be a majority vote method.

The approach taken by the RSM is to select, at random, a subset of the features of the full problem and to use these features alone to train one of the “basis” classifiers used in the ensemble. If a large number of basis classifiers are trained in this way, then it is possible that the ensemble will have a superior performance to that of a single classifier trained on the full feature space. This has been found to be the case in a number of application domains.

An additional benefit of this approach relates to its use on small training datasets. If the size of the training dataset is smaller than the dimensionality of the original problem, then the class statistics become either difficult or impossible to estimate and it may turn out to be impossible to use the chosen decision rule of the basis classifiers. By restricting the size of the feature space for each basis classifier, such that the class statistics for each ensemble element are calculable, then it becomes possible to produce classifications in this difficult case.

In the RSM, the set of features are selected randomly for each ensemble basis classifier. To ensure that at least most of the available features are used, a large number of basis classifiers must be used in the ensemble. Referring to FIG. 1, an example is shown of a simple classifier designed according to the RSM and having an ensemble of only four basis classifiers. However, the use of a large number of basis classifiers results in a significant computational requirement when using the method which, in turn, can make the RSM unattractive to use in time-critical applications.

Another example of an available subspace selection method is the “Classical Feature Extraction” method, described for example by Fukunaga, K., in the book “Introduction to Statistical Pattern Recognition”, Second Edition, Academic Press, 1990. In this method, much of the processing is carried out offline to select the combination of features from the feature space most likely to ensure class separability. Only the selected subset of each feature vector for elements to be classified is then input to a single classifier with relatively low operational processing requirements. However, the selection technique in the classical feature selection method is, to a large extent, based on the statistical properties of the available training data and may therefore suffer from the same problems as the classifiers themselves when training datasets are small. That is, the poor estimation of class mean vectors, covariance matrices or scatter matrices can, in turn, lead to poor estimates of the set of discriminatory features.

As sensor technology develops, the quantity of data that can be made available to image classification systems is ever increasing. Techniques with a large processing requirement are therefore likely to be of limited application for some time to come if the full range of available sensor data is to be exploited.

### SUMMARY OF THE INVENTION

From a first aspect, the present invention resides in an apparatus for classifying elements, in particular elements within an image, wherein an element is defined by a vector of feature values, the apparatus comprising:

a classifier arrangement comprising a plurality of classifiers each operable, in respect of an element to be classified, to receive a different predetermined subset of the feature values from the element feature vector and wherein, in operation, each said classifier is trained in respect of a predetermined set of classes using training data representative of elements in each said class; and

a combining arrangement operable to combine outputs from the plurality of classifiers to determine which of the predetermined classes to associate with an element to be classified,

characterized in that each of said different predetermined subsets of feature values comprise a different cyclic selection of the feature values such that, in operation, adjacent feature values in an element feature vector are input to different ones of said plurality of classifiers and all feature values are input to at least one classifier.

Features may be selected cyclically according to “round robin” basis. As such, the subspace selection technique embodied in exemplary embodiments of the present invention will be referred to as the “structured subspace method”.

Exemplary embodiments of the present invention therefore approach the problem of distributing closely matched features in the feature space across an ensemble of basis classifiers in a structured manner, so greatly reducing the number of classifiers required while still making use of the full feature space available.

In some applications it may be appropriate for exemplary embodiments of the present invention to be used to provide initial indications of a class of object in a image and for a further classifier, designed according to the random subspace approach for example, to be used to further refine the classification of that object where time is not so critical.

Majority voting is the exemplary technique by which the output of basis classifiers may be combined to produce a classification decision, although other forms of voting, such as posterior probability, may be used.

By way of an example of the type of image to which exemplary embodiments of the present invention may be applied is the well-known AVIRIS Indian Pines image (Landgrebe, D. A., Biehl, L., “AVIRIS Indian Pines Reflectance Data: 92AV3C”, available as a part of the documentation for the MultiSpec hyperspectral imagery analysis environment at the internet address http://dynamo.ecn.purdue.edu/-biehl/MultiSpec/documentation.html), a largely agricultural scene containing some difficult to separate classes of ground cover.

From a second aspect, the present invention resides in a method for classifying elements, in particular elements within an image, wherein an element is defined by a vector of feature values, the method comprising the steps of:

(i) using, for each a set of predetermined classes, a training dataset representative of elements in the class to train a plurality of classifiers in respect of the class, wherein each classifier is operable to receive feature vector values in respect of a different predetermined cyclic selection of features such that adjacent feature values in an element feature vector are input to different ones of said plurality of classifiers and all feature values are input to at least one classifier;

(ii) receiving a feature vector for an element to be classified;

(iii) inputting the received feature vector values to said plurality of trained classifiers according to said predetermined cyclic selections and generating a plurality of classifier outputs; and

(iv) combining the classifier outputs to determine which of said predetermined classes to associate with the element to be classified.

### BRIEF DESCRIPTION OF THE DRAWINGS

FIG. 1 shows an example of an available classifier based upon random subspace selection as discussed above.

FIG. 2 shows an example of a classifier according to an exemplary embodiment of the present invention.

### DETAILED DESCRIPTION

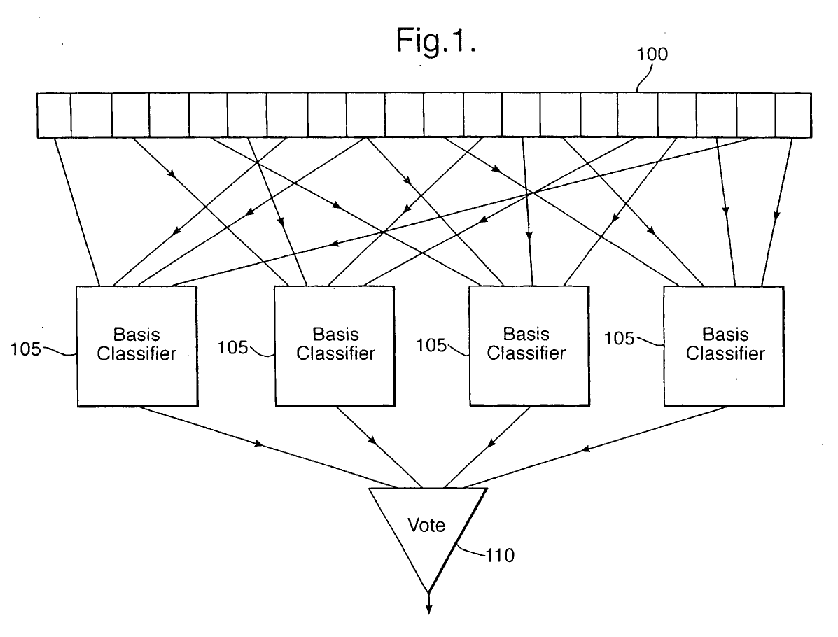

A known classifier designed according to the known random subspace method (RSM), as discussed above, will firstly be summarized with reference to FIG. 1.

Referring to FIG. 1, a feature vector 100 is shown comprising all features of the available feature space. In the example of a hyperspectral image classifier, the feature vector 100 representing an element of an image to be classified comprises a vector of intensity values for each of the frequency bands of the image.

According to the RSM, the features represented by the feature vector 100 are associated in a random manner with an ensemble of basis classifiers 105 such that the number of features input to each basis classifier 105—the subspace dimension—is the same. However, as can be seen from FIG. 1, because the selection of features for each basis classifier 105 is random, not all features are necessarily selected for consideration by the ensemble in classifying a given element feature vector 100. The best that can be achieved is to provide a sufficient quantity of basis classifiers 105 in the ensemble so that the probability of selection of any one feature is at least a predetermined figure, e.g. 99%. Clearly, the higher the figure, the greater the number of basis classifiers 105 that need to be provided in the ensemble.

The results from each basis classifier 105 of the ensemble in respect of an element to be classified are input to a vote 110 where the results are combined by a majority vote to determine the classification result.

A particular disadvantage of the classifier of FIG. 1 is the high level of processing required to train and operate the classifiers 105 given their large number.

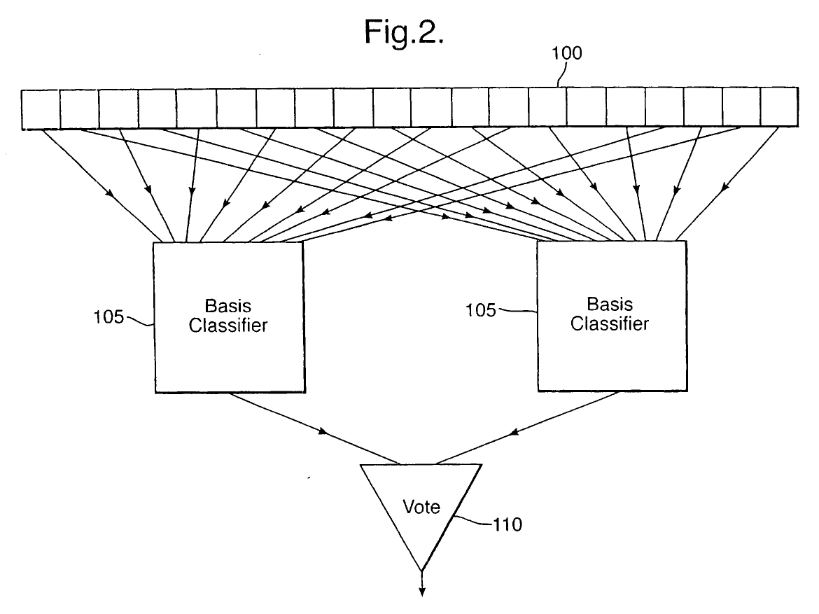

An exemplary embodiment of the present invention will now be described with reference to FIG. 2. Features of FIG. 2 in common with FIG. 1 are labelled with the same reference numerals.

Referring to FIG. 2, a feature vector 100 defining an element to be classified is shown, spanning the available feature space as for the classifier of FIG. 1. However, in the exemplary method of the present invention, a structured approach is taken to the association of features of the feature vector 100 with each of a predetermined number of basis classifiers 105, in this example with two basis classifiers 105. This approach guarantees that all the features of a feature vector 100 are considered by the ensemble of basis classifiers 105 while ensuring also that, where adjacent features are closely related, they are distributed amongst the classifiers 105 in the ensemble.

Features may be associated with each of the basis classifiers 105 using a cyclic, or “round-robin” selection. In the specific example of FIG. 2 having two basis classifiers 105, features are associated alternately with one classifier 105 then the other throughout the length of the feature vector 100 until all features are assigned. As for FIG. 1, the results of the trained classifiers 105 are combined in a vote 110 to determine the classification results for a given element feature vector 100.

Where the number of classifiers does not exactly divide the number of features, elements of the feature vector 100 may be reused such that all basis classifiers 105 have the same dimensionality. This approach guarantees that all elements of the feature vector are assigned to at least one basis classifier 105 and, for a given subspace dimensionality, a significantly smaller number of basis classifiers 105 is required to span the available feature space, in comparison with a classifier designed according to the RSM, with consequent savings on processor loading during training and operation.

Although an exemplary embodiment of the present invention has been discussed in the context of hyperspectral image classification, it will be clear that a feature vector 100 defining an element of an image to be classified need not relate to bands of optical frequencies as in hyperspectral images, but may relate to other types of feature in an “image” by which elements may be defined and classified. The word “image” is used broadly in the present patent specification to mean not only an optical image where, for example, features may represent the intensity of a pixel in each of a number of optical frequency bands, but also an image defined in terms of other feature parameters, for example those characterising an image generated using magnetic resonance interferometry (MRI) or other “imaging” technique.

As explained in the introductory part of the present patent specification, the exemplary embodiment of the present invention is an example of a selected subspace method in which an ensemble of classifiers is assembled. The underlying, or “basis” classifiers used in the ensemble may be of any one of a number of known types. For example, the basis classifiers may be of a type known as a quadratic Bayes classifier, described for example in the book by Fukunaga, referenced above, with slight modifications required to deal with singular covariance matrices, i.e. if a class conditional covariance matrix is found to be ill-conditioned it is replaced by the common covariance matrix of all classes; if the common covariance matrix is also found to be ill-conditioned then its diagonal only is used.

An alternative choice of basis classifier is a neural network. The choice of classifier is not therefore an essential feature of the present invention and will not be described further in this patent specification.

In practice, for example using the data used is a part of a scene collected by the Airborne Visual and near infra red (IR) Imaging Spectrometer (AVIRIS) referenced above, it has been found that there may be considerable correlation between neighboring elements of the feature vector 100. The structured subspace method of the present invention advantageously disperses these correlated elements throughout the classifier ensemble, thereby ensuring that each basis classifier 105 is, individually, a good subspace classifier. An ensemble built from such a collection might be expected to improve on the performance in respect of any individual element to be classified.

In practice, it has been found that the structured subspace approach of the present invention method closely follows the performance of the random subspace method. However, while the latter may often be able to deliver a marginally better peak performance, it is at a considerably higher computational cost.

Both the known random subspace ensemble method and the structured subspace method of the present invention have been found applicable to difficult classification problems for pixels in hyperspectral imagery. The techniques are particularly effective for the difficult cases in which the training set sizes are small compared to the dimensionality of the problem. The present structured subspace method is able to produce results very close to those achievable using the random subspace method, but using a significantly smaller ensemble of basis classifiers 105, and therefore at a significantly reduced computational cost.

The present invention has been described, by way of example only, and it will be appreciated that variation may be made to the exemplary embodiments described without departing from the scope of present invention. For example the present invention may be employed in spectroscopy, in classifying pixels within images obtained from imaging equipment such as digital cameras, charge coupled devices (CCDs), magnetic resonance imagers (MRI) or other imaging devices operating at optical and other wavelengths. The present invention may also be used in novelty identification and in a range of applications in which a large amount of sensor data, across a broad waveband, needs to be assessed for classification quickly and efficiently.

1-4. (canceled)

5. An apparatus for classifying elements, in which an element is defined by a vector of feature values, the apparatus comprising:
a classifier arrangement including a plurality of classifiers, each operable, in respect of an element to be classified, to receive a different predetermined subset of the feature values from the element feature vector, wherein, in operation, each said classifier is trained in respect of a predetermined set of classes using training data representative of elements in each said class; and
a combining arrangement operable to combine outputs from the plurality of classifiers to determine which of the predetermined classes to associate with an element to be classified,
wherein each of said different predetermined subsets of feature values include a different cyclic selection of the feature values such that, in operation, adjacent feature values in an element feature vector are input to different ones of said plurality of classifiers and all feature values are input to at least one classifier.

6. The apparatus of claim 5, arranged for use in classifying pixels in a hyperspectral image, wherein each of said feature vector values is associated with a different respective frequency band in the hyperspectral image.

7. The apparatus of claim 6, wherein each of said feature vector values represents an intensity of light in a respective frequency band.

8. A method for classifying elements, in which an element is defined by a vector of feature values, the method comprising:
using, for each a set of predetermined classes, a training dataset representative of elements in the class to train a plurality of classifiers in respect of the class, wherein each classifier is operable to receive feature vector values in respect of a different predetermined cyclic selection of features such that adjacent feature values in an element feature vector are input to different ones of said plurality of classifiers and all feature values are input to at least one classifier;
receiving a feature vector for an element to be classified;
inputting the received feature vector values to said plurality of trained classifiers according to said predetermined cyclic selections and generating a plurality of classifier outputs; and
combining the classifier outputs to determine which of said predetermined classes to associate with the element to be classified.

9. The method of claim 8, wherein the elements are within an image.

10. The apparatus of claim 5, wherein the elements are within an image.
